(19) United States
(12) Patent Application Publication
(10) Pub. No.: US 2005/0105721 A1
(43) Pub. Date: May 19, 2005

(54) Image forming apparatus and data reading method

(75) Inventor: Tomohiro Ono, Ebina-shi (JP)

Correspondence Address: MORGAN LEWIS & BOCKIUS LLP, 1111 PENNSYLVANIA AVENUE NW, WASHINGTON, DC, 20004, US

(73) Assignee: FUJI XEROX CO., LTD.

(21) Appl. No.: 10/868,035

(22) Filed: Jun. 16, 2004

(30) Foreign Application Priority Data
Nov. 14, 2003 (JP) 2003-385780

(51) Int. Cl. H04L 9/00; G03G 15/00

(52) U.S. Cl. 380/51; 399/1

(57) ABSTRACT

An image forming apparatus includes a controller that controls an IC memory that stores control information necessary to print electronic image data and is mountable in and dismountable from a main body thereof, and a reading section that reads the control information from the IC memory. Herein, the image forming apparatus has a decrypting section that decrypts the control information encrypted using a cryptographic key stored in advance, an error checking section that detects an error by checking the control information obtained by the decrypting section with error check codes added in advance, and a destruction judgment section that judges whether the control information is destroyed, by information of the decrypting means and the error checking section, and the destruction judgment section can decrypt the control information.

### BACKGROUND OF THE INVENTION

1. Field of the Invention

The present invention relates to an image forming apparatus such as a digital copier or printer that has a section that reads plural encrypted data pieces in a section that reads from and writes to a unit that records operation information for image formation, the unit being mountable in or dismountable from the image forming apparatus.

2. Description of Related Art

There have been conventionally units mountable in and dismountable from image forming apparatuses such as printers, scanners, or copiers. These types of units have a memory. For example, in an electrophotographic printer and a digital copier that use an electrophotographic image formation process, a process cartridge system is adopted in which a process section, a developing section, and a cleaning section to act on an electrophotographic photoconductive material are integrated into a cartridge as a dismountable unit. According to the process cartridge system, since maintenance on the electrophotographic printer and the like can be performed by users themselves without relying on servicemen, usability can be improved. Presently, the process cartridge system is widely used in electrophotographic printers and the like.

Some of these electrophotographic printers have a programmable nonvolatile memory within a process cartridge. The nonvolatile memory holds an ID number, a manufacturer name, and reuse history and count.

Electrophotographic printers and the like are provided with a transmitting/receiving part that reads information necessary for an image formation operation from a nonvolatile memory. When a print operation is started, the abovementioned information stored in advance in the nonvolatile memory is read through the transmitting/receiving part and used for control of different parts of the electrophotographic printers and the like to perform the print operation.

Conventionally, nonvolatile memories capable of holding data even if power is not supplied have been used. However, since the nonvolatile memories have a low write speed, if power is turned off during writing, write data may fail to be written. Also, since the nonvolatile memories are lower in data holding precision than other memories, data may be corrupted. For these reasons, as a method often used for increasing data holding precision, plural data pieces having the same contents is written at plural locations, and during reading, the plural data pieces are compared to make a decision by majority. Also, as proposed in Patent Reference 1 below, part or all of data stored in a nonvolatile memory is encrypted to prevent tampering.

[Patent Reference 1] Japanese Published Unexamined Patent Application No. 2002-366008

However, if data is held at plural locations, the amount of data read from the nonvolatile memory increases by the plural locations, and all of control information necessary for printing is read from the nonvolatile memory. As a result, a long read time is required. Moreover, since data tampering detection sections such as encryption and CRC require a long time to perform the decryption, and involve reading all data into the apparatus from the nonvolatile memory and performing majority decision processing, similarly, a long processing time is required.

### SUMMARY OF THE INVENTION

To solve the abovementioned problems, the present invention provides an image forming apparatus as described below. The image forming apparatus includes: a controller that controls an IC memory that stores control information necessary to print electronic image data and is mountable in and dismountable from a main body thereof, and devices within the main body for printing; and a reading section that reads the control information from the IC memory. Herein, the image forming apparatus includes: a decrypting section that decrypts the control information encrypted using a cryptographic key stored in advance; an error checking section that detects an error by checking the control information obtained by the decrypting section with error check codes added in advance; and a destruction judgment section that judges whether the control information is destroyed, by information of the decrypting section and the error checking section. The destruction judgment part can decrypt the control information at even one location, the control information being stored at plural locations of the IC memory, one item at each location, and terminates item reading if the checking is judged normal by the error checking section.

### BRIEF DESCRIPTION OF THE DRAWINGS

Preferred embodiments of the present invention will be described in detail based on the followings, wherein:

FIG. 1 is a block diagram showing a system configuration of this embodiment;

FIG. 2 is a drawing showing the overall configuration of a digital copying system;

FIG. 3 is a drawing showing the overall configuration of a digital copier of this embodiment;

FIG. 4 is a flowchart of door open/close detection processing necessary to call the number of sheets printed recorded in CRUM having a nonvolatile memory within a process cartridge;

FIG. 5 is a flowchart showing the flow of data extraction processing in a first embodiment;

FIG. 6 is a flowchart showing the flow of data extraction processing in a second embodiment; and

FIG. 7 is a block diagram showing a system configuration in a third embodiment in which wireless communication is used.

### DETAILED DESCRIPTION OF THE PREFERRED EMBODIMENTS

Hereinafter, embodiments of the present invention will be described with reference to the accompanying drawings.

1. Overall Configuration

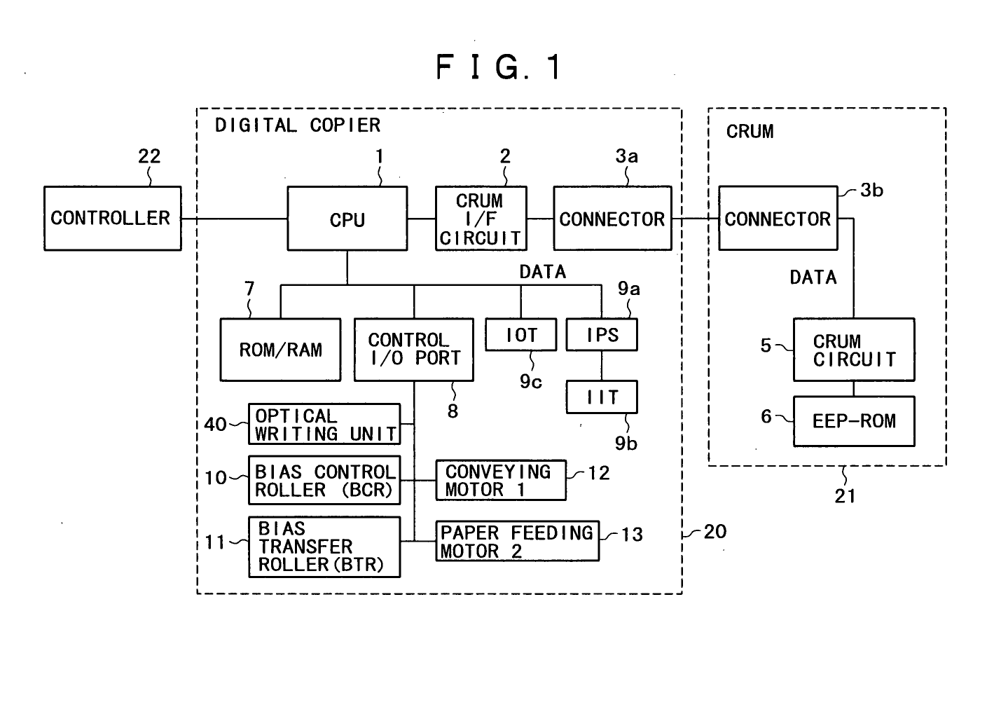

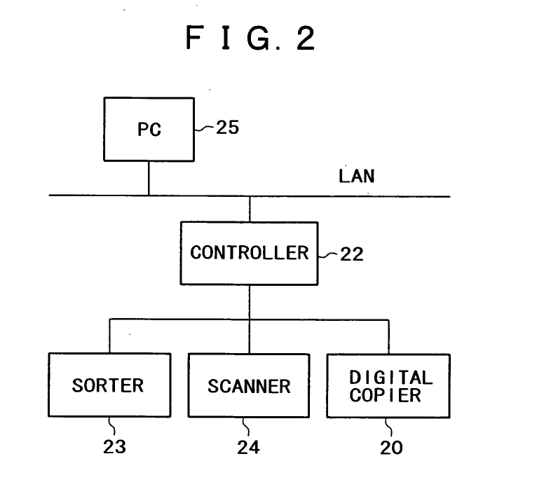

First, a digital copier and a system configuration will be described using FIGS. 1 and 2. FIG. 1 is a block diagram showing a system configuration of this embodiment, and FIG. 2 is a drawing showing the overall configuration of a digital copying system.

In FIG. 2, the digital copying system includes a controller 22, a scanner 24, a digital copier 20, and a sorter 23. A PC 25 and the controller 22 are connected by LAN, and the scanner 24, the digital copier 20, and the sorter 23 are connected to the controller. The digital copying system operates not only as an ordinary copier but also as a printer in which the controller 22 controls printout requests from the PC 25 on the LAN and directs the digital copier 20 to perform printing.

As shown in FIG. 1, the digital copier 20 is controlled by a CPU 1. The CPU 1 is connected with a ROM/RAM 7, a control I/O port 8, a CRUM I/F circuit 2, an IPS (Image Processing System) 9a, an IIT (Image Input Terminal) 9b, and an IOT (Image Output Terminal) 9c. CRUM (Customer Replaceable Unit Memory) 21 is a user-replaceable nonvolatile memory module including EEP-ROM 6. The CRUM 21 is incorporated in a process cartridge of the digital copier. The CPU 1 performs writing to and reading from the EEP-ROM 6 via the CRUM I/F circuit 2, connectors 3a and 3b, and a CRUM circuit 5.

Furthermore, the CPU 1 is connected with plural units via the IPS (Image Processing System) 9a, the IIT (Image Input Terminal) 9b, the IOT (Image Output Terminal) 9c, and the control I/O port 8. Control signals from the CPU 1 are transmitted to plural units such as an optical writing unit 40, a bias control roller (BCR) 10, a bias transfer roller (BTR) 11, a conveying motor 1 (12), and a paper feeding motor 2 (13) via the control I/O port 8.

The IIT 9b is a module such as the scanner 24 in FIG. 2 that processes signals optically produced from a document to be copied. The IPS 9a is a module that performs processing such as tone correction and data compression for the image data of the document obtained by the IIT. The image data compressed by the IPS 9a is supplied to the IOT 9c under control of the CPU 1. From the received image data, the IOT 9c forms an image on paper by means of units such as the optical writing unit 40, the bias control roller (BCR) 10, the bias transfer roller (BTR) 11, the conveying motor 1 (12), and the paper feed motor 2 (13) via the I/O port 8 shown in FIG. 1.

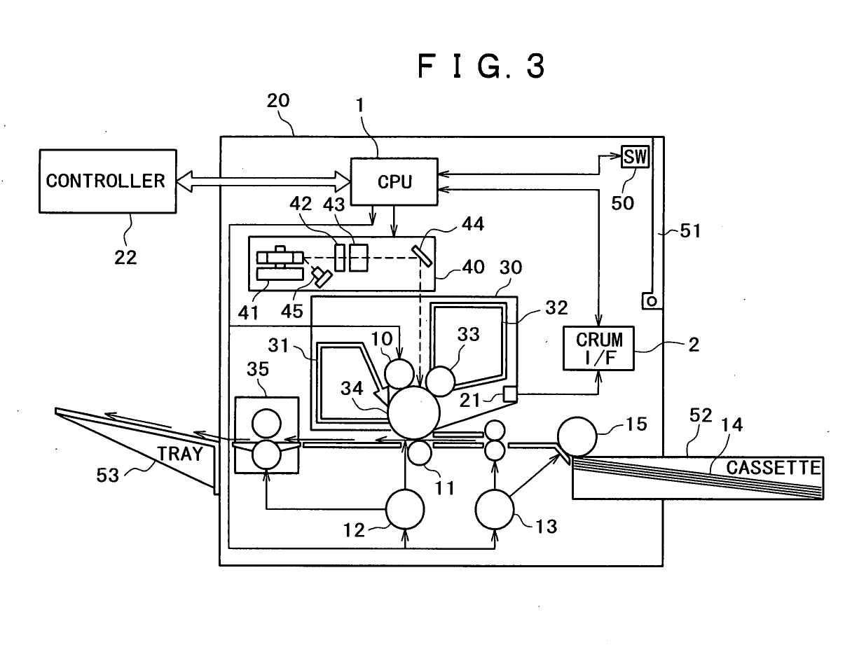

FIG. 3 is a drawing showing the overall configuration of the digital copier 20 of this embodiment. The digital copier 20 according to this embodiment is controlled as a copying system by the controller 22, with the CPU 1 connected to the controller 22. The digital copier 20 is equipped with a process cartridge 30 that is mountable in and dismountable from the copier body. The process cartridge 30 has a CRUM 21 including a nonvolatile memory. The digital copier 20 includes a cassette 52 loaded with paper 14, a paper feeding roller 15, the paper feeding motor 2 (13) driving the paper feeding roller 15, a photoconductive drum 34 of the process cartridge 30, the bias control roller (BCR) 10, a developing roller 33, a conveying motor 1 (12) that drives a bias transfer roller (BTR) 11, a fixing roller 35, and other drums, a tray 53 that holds paper printed and discharged, an optical writing module 40, a CRUM I/F circuit 2, and a maintenance door 51 and a door switch 50 for the digital copier 20.

The process cartridge 30 of this embodiment includes the photoconductive drum 34, the bias control roller (BCR) 10, the developing roller 33 that applies toner from the developing unit 32 to the photoconductive drum 34, the bias transfer roller (BTR) 11 that transfers charges to paper 14, a cleaner 31 for reclaiming waste toner provided with a cleaning part, and the photoconductive drum 34. Moreover, the optical writing unit 40 is provided to partially eliminate charges of the photoconductive drum 34 by laser light.

The optical writing module 40 sends laser light from a laser diode 45 by a polygon mirror 41 to a mirror 44 via a condenser lens 42 and a spectral lens 43, and guides it to the photoconductive drum 34 via the mirror 44. The process cartridge 30 incorporates the CRUM 21, which includes the connector 3b, the CRUM circuit 5, and the EEP-ROM 6. Moreover, the connector 3a of the digital copier 20 is disposed in the vicinity of the CRUM 21.

Next, referring to FIG. 3, an outline of the operation of the digital copier will be described according to the flow of the paper 14 shown by the arrows in the drawing. The paper 14 stored in the cassette 52 is conveyed by the paper feeding roller 15 driven by the paper feeding motor 2 (13) to the photoconductive drum 34. Of plural units or rollers driven by the conveying motor 1(12), the photoconductive drum 34 is driven into clockwise revolution, at which time its surface is charged by the bias control roller (BCR) 10 and laser light is applied from the optical writing unit 40 to form a latent image on the photoconductive drum 34. When passing through the developing roller 33, the latent image is made into a visible image by toner. The visible image on the photoconductive drum 34 is transferred to the paper 14 conveyed to the photoconductive drum 34 by the bias transfer roller (BTR) 11. Thereafter, the paper is conveyed to the fixing roller 35, where the visible image on the paper 14 is fixed. The paper is discharged out of the digital copier 20 and stored in the tray 53.

The process cartridge 30 of the digital copier 20 of this embodiment is provided with a board configured with an IC chip having a programmable memory incorporated in the process cartridge 30, and ASIC, and the connector 3a for transmitting signals that is provided on the board. Using this signal line, various data related to the process cartridge 30 is stored in the EEP-ROM 6. The data includes (1) the number of sheets printed, (2) the cumulative number of revolutions and revolution time of the photoconductive drum 34 of the process cartridge 30, (3) the cumulative number of revolutions of a motor for supplying toner, (4) surface potential indicating a deterioration condition of the photoconductive drum 34, (5) electrification current or voltage due to wear-out of the photoconductive drum 34, and (6) data for managing the amount of laser light and the limitation of use of the process cartridge 30. Data changing with use is read and written as required. Since the control of reading from and writing to the EEP-ROM 6 is performed by the CPU 1 that controls the main body, when the process cartridge is mounted in the main body, the EEP-ROM 6 is connected with the CPU 1 of the main body via the connectors 3a and 3b.

The CPU 1 controls the operation of the digital copier 20, and data of the nonvolatile memory EEP-ROM6 can be read and written by the CPU 1 via the CRUM circuit 5 and the CRUM I/F circuit 2. In this embodiment, the CRUM I/F circuit 2 is disposed between the CRUM 21 and the CPU 1 of the main body, and connected with the nonvolatile memory EEP-ROM 6 of the CRUM 21 through an I²C (I square C) bus. The I²C bus is a two-wire serial bus for performing serial communication by use of one clock wire and one data wire.

2. Example of Operation States

(1) At Activation or Door Open

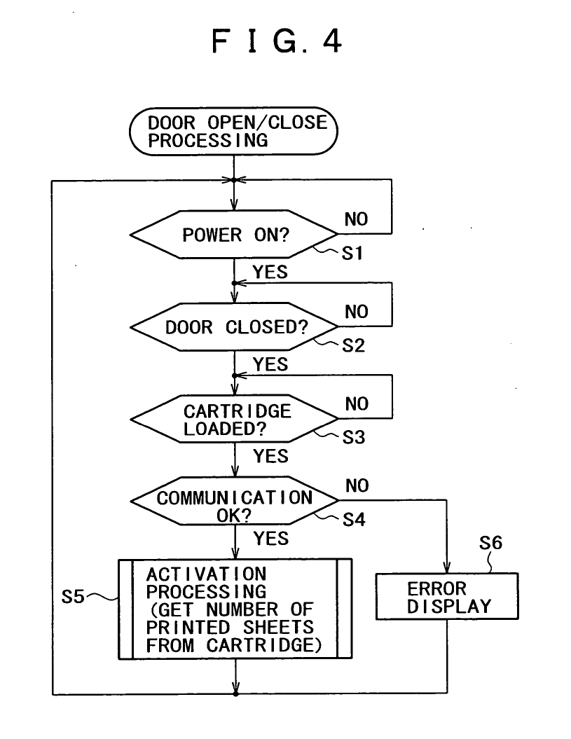

FIG. 4 is a flowchart of door open/close detection processing necessary to get the number of sheets printed recorded in the CRUM 21 within the process cartridge 30. Using FIG. 4, a description will be made of an embodiment relating to the management of use limitation of the process cartridge 30. In this embodiment, processing is performed for notifying the user when the total number of printed sheets of the CRUM 21 reaches an upper limit on the number of sheets printed as a management item. Since the process cartridge 30 can be mounted and dismounted by the user, door open/close processing of the digital copier 20 is activated to determine whether the process cartridge 30 has been mounted or dismounted.

The CPU 1 can detect by the door switch 50 whether the door 51 shown in FIG. 3 is open or closed. In step S1, the system determines whether power to the main body is on, and if not so, the system does not go ahead. Although a mechanical door switch is used in this embodiment, other optical switches may be used. If the power is on, the system proceeds to step S2, where upon detecting by the door switch 50 that the door is open, the system waits until the door is closed. If the door is closed, in step S3, the system accesses the process cartridge 30 to determine whether the process cartridge 30 is loaded.

Upon detecting that the process cartridge 30 is loaded, in step S4, the system starts communication by a predetermined communication protocol, and determines whether normal communication is possible. Time taken for communication is measured, and if no response is made or communication is not established after time (about 20 ms) within which the EEP-ROM 6 responds without fail has elapsed, and if more than three errors occur successively in step S6, an error is displayed. If communication is established, the system gets the number of printed sheets from the process cartridge 30 and determines whether it exceeds an upper limit on the number of sheets printed.

### First Embodiment

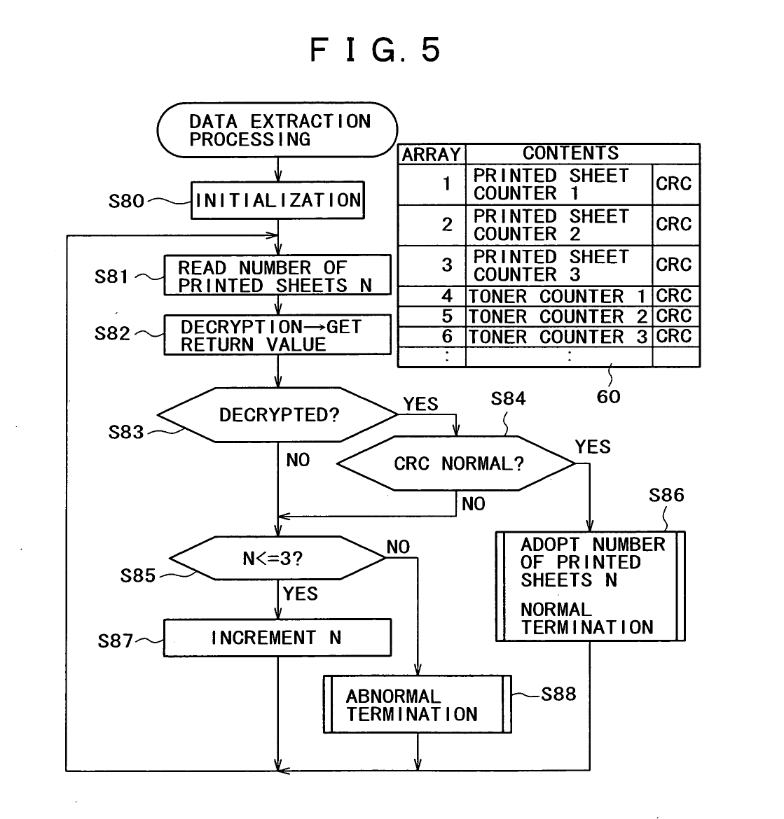

FIG. 5 is a flowchart showing the flow of data extraction processing in the first embodiment. A printed sheet counter and a toner counter stored in the EEP-ROM 6 of the process cartridge 30 mounted in the digital copier 20 are held as a data group 60 including CRC data for detecting data destruction as shown in FIG. 5. As its data structure, control information encrypted by cryptographic key is written three times, wherein CRC error check codes are added to the control information. This data is read into the ROM/RAM 7 within the digital copier 20 when the digital copier has been activated, or after the units have been stored.

(2) Extracting Data

The flow of data extraction is described using FIG. 5. In step S80, an array counter N required for processing is set to “1” and others are initialized. Next, in step S81, the number of printed sheets N is read, and the value “1” set in the array counter N indicated by data “printed sheet counter 1” is read from the EEP-ROM 6 into the ROM/RAM 7 of the digital copier. In step S82, encrypted data of “printed sheet counter 1” is decrypted using cryptographic key stored in advance. If the decryption succeeds in step S83 and the data can be confirmed to be neither tampered nor destroyed (Yes), control proceeds to step S84, where CRC error checking is performed. If CRC check codes are determined to be valid in the CRC error checking, in step S86, without reading out the data of the remaining “printed sheet counters 2 and 3” (N=2, 3) and performing decryption, the value of “printed sheet counter 1” is adopted and the processing terminates normally.

Further, control proceeds with the array counter N set to 4. “Toner counter 1” is read out and the encrypted data is decrypted. If the decryption succeeds and the data can be confirmed to be neither tampered nor destroyed, CRC error checking is performed. If CRC check codes are determined to be valid in the CRC error checking, similarly, without reading out the data of other “toner counters 2 and 3” and performing decryption, the value of the toner counter 1 is adopted. In the first embodiment, processing based on data of six locations is described. In the same way, processing follows.

If the “printed sheet counter 1” cannot be decrypted, and if the decryption has succeeded but CRC check codes are determined to be not valid in the CRC error checking, control passes through step S85 that counts three retries, the array counter N is incremented to read out “printed sheet counter 2” in the step S81. If the decryption succeeds in the step S82 and the CRC error checking in the step S84 is performed normally, the number of printed sheets N is adopted. If the decryption in the step S83 is impossible, and if CRC error checking is not performed normally in the step S84, it is checked in the step S85 whether data of three locations has not been read out (the array counter N is smaller than 3). If the checking results in Yes, the array counter N is incremented in the step S87 and “printed sheet counter 3” is read out. If abnormality is detected in the steps S83 and S84, since the array counter N is equal to or greater than 3, control goes from the step S85 to step S88, where an error is displayed in a display unit (not shown) of the digital copier to indicate abnormal termination.

### Second Embodiment

(3) Extracting Data by Block Reading

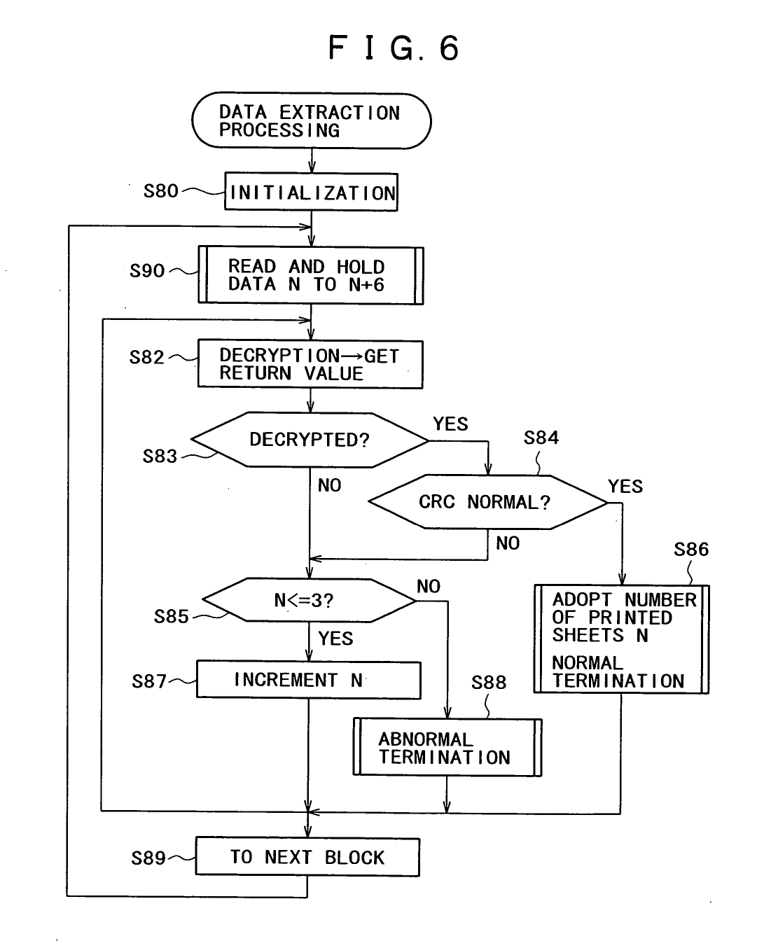

FIG. 6 is a flowchart showing the flow of data extraction processing in a second embodiment. In the first embodiment, data pieces are read out one by one from a nonvolatile memory. In the second embodiment, depending on types of nonvolatile memories, in the case where a read speed is increased by reading blocks each containing plural items, “printed sheet counter 1” through “toner counter 3” (N=1 to 6) are read from the EEP-ROM 6 onto RAM to speed up processing.

First, initialization is performed in step S80. In step S90, two items and six data pieces of “printed sheet counter 1” through “toner counter 3” are read from the EEP-ROM 6 to the ROM/RAM 7. Next, of the read data, the encrypted data of “printed sheet counter 1” is decrypted in the step S82. If the decryption succeeds in the step S83, CRC error checking is performed normally in the step S84, and the data can be confirmed to be neither tampered nor destroyed, the value of “printed sheet counter 1” is adopted without decrypting the data of “printed sheet counters 2 to 3” in the step S84. Next, control returns to the step S90, where the data of the read “toner counters 1 to 3 is outputted. The data of “toner counter 1” is decrypted in the step S82, and if the decryption succeeds in the step S83, CRC error checking is performed normally in the step S84, and the data has been confirmed to be neither tampered nor destroyed, similarly, the value of “toner counter 1” is adopted in the step S86. This processing omits useless data reading and decryption.

If the first decryption of “printed sheet counter 1” does not succeed and the decryption fails, decryption is performed using the data of the next “printed sheet counter 2” and “printed sheet counter 3”. As a result, a value that has been encrypted normally and determined to be valid in CRC error checking is adopted. This processing speeds up reading from the EEP-ROM.

3. Write Processing

In this embodiment, a description has been made of the reading of control information of the EEP-ROM 6 within the CRUM 21 into the digital copier 20. In processing that writes control information about printing to the EEP-ROM 6 each time printing terminates, CRC error check codes are added to the control information, and the control information encrypted by a cryptographic key is written to the EEP-ROM 6. Such writing is performed three times while incrementing the array counter, thereby preventing data from being tampered or destroyed.

### Third Embodiment

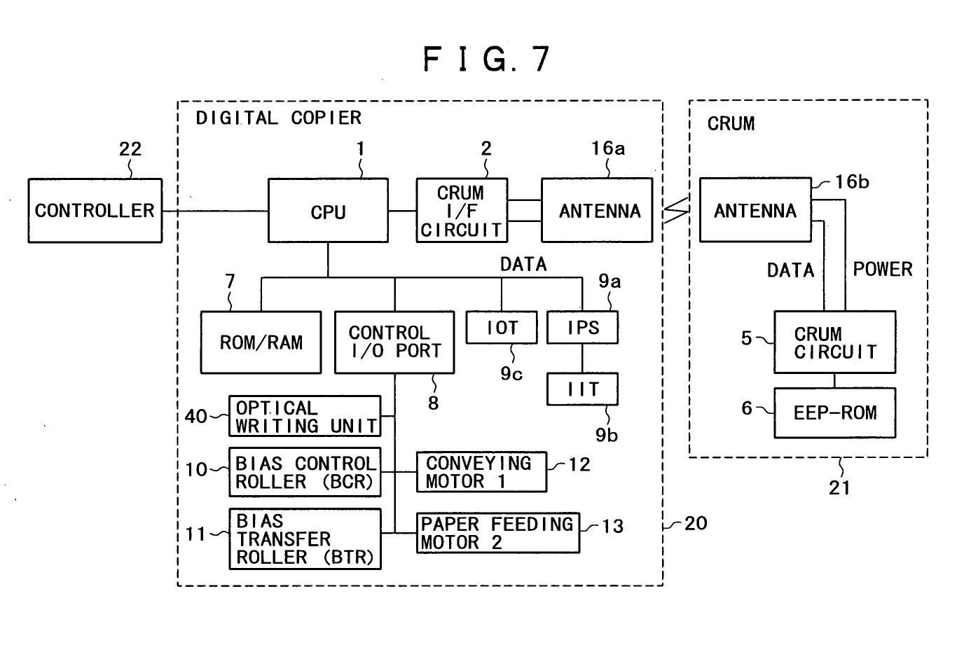

FIG. 7 is a block diagram showing a system configuration in a third embodiment in which wireless communication is used. In FIG. 7, terminals between the CRUM 21 having the EEP?ROM 6 and the digital copier 20 are connected in non-contact mode by use of wireless signals instead of being connected by connectors so that wireless communication is conducted between antennas. The CPU 1 modulates an I²C signal converted in the CRUM I/F circuit 2 by a radio carrier and transmits the radio signal from an antenna 16a to an antenna 16b. The CRUM 21 includes the antenna 16b, the CRUM circuit 5, and the EEP-ROM 6, which is connected to the CRUM circuit 5. The signal transmitted from the antenna 16a of the digital copier 20 is received by the antenna 16b of the CRUM 21, and the CRUM circuit 5 demodulates the radio carrier to take out the I²C signal so that a read or write is made to the EEP-ROM 6.

When this mode is used, the wireless communication is interfered by electromagnetic noise generated from the inside of the digital copier, resulting in an increase in the number of retries in data communication. A description is made of a third embodiment that uses the data extraction method according to the first and second embodiments. In the third embodiment, block transfer shown in FIG. 6 is performed in data extraction processing on data transmitted between the antennas 16a and 16b shown in FIG. 7, and even if data is damaged due to noise intermittently generated, since only data of one location is used in decryption and error checking of this embodiment, the number of pieces of data required for communication can be reduced.

The image forming apparatus of the present invention further includes a block reading section that reads plural pieces of the control information from the IC memory on a block basis. Herein, the destruction judgment section can decrypt, in the unit of a block containing plural items, the control information at even one location, the control information being stored at the plural locations of the IC memory, each one of the items at each location, and terminates reading of one item if the checking is judged normal by the error checking section, and reads a next item.

Moreover, in the image forming apparatus of the present invention, the control information necessary to print electronic image data is added with error check codes per printing, and is further encrypted by the cryptographic key and stored at the plural locations of the IC memory, one item at each location.

The present invention provides a writing method of an image forming apparatus that includes a control process that controls an IC memory that stores control information necessary to print electronic image data and is mountable in and dismountable from the main body, and devices within the main body for printing; and a reading process that reads the control information from the IC memory. Herein, the writing method of the image forming apparatus includes: a decrypting process that decrypts the control information encrypted using a cryptographic key stored in advance; an error checking process that detects an error by checking the control information obtained by the decrypting process with error check codes added in advance; and a destruction judgment process that judges whether the control information is destroyed, by information of the decrypting process and the error checking process. The destruction judgment process can decrypt the control information at even one location, the control information being stored at plural locations of the IC memory, one item at each location, and terminates item reading if the checking is judged normal by the error checking process.

The writing method of the image forming apparatus further includes a block reading process that reads plural pieces of the control information from the IC memory on a block basis. Herein, the destruction judgment process can decrypt, in the unit of a block containing plural items, the control information at even one location, the control information being stored at the plural locations of the IC memory, each one of the items at each location, and terminates reading of one item if the checking is judged normal by the error checking process, and reads a next item.

Moreover, in the writing method of the image forming apparatus of the present invention, the control information necessary to print electronic image data is added with error check codes per printing, and is further encrypted by the cryptographic key and stored at the plural locations of the IC memory, one item at each location.

The present invention provides a storage medium readable by a computer, the storage medium storing a writing program of an image forming apparatus executable by the computer that includes a control step that controls an IC memory that stores control information necessary to print electronic image data and is mountable in and dismountable from the main body, and devices within the main body for printing; and a reading step that reads the control information from the IC memory. Herein, the writing method of the image forming apparatus includes: a decrypting step that decrypts the control information encrypted using a cryptographic key stored in advance; an error checking step that detects an error by checking the control information obtained by the decrypting step with error check codes added in advance; and a destruction judgment step that judges whether the control information is destroyed, by information of the decrypting step and the error checking step. The destruction judgment step can decrypt the control information at even one location, the control information being stored at plural locations of the IC memory, one item at each location, and terminates item reading if the checking is judged normal by the error checking step.

The storage medium readable by a computer, the storage medium storing the writing program of the image forming apparatus further includes a block reading step that reads plural pieces of the control information from the IC memory on a block basis. Herein, the destruction judgment step can decrypt, in the unit of a block containing plural items, the control information at even one location, the control information being stored at the plural locations of the IC memory, each one of the items at each location, and terminates reading of one item if the checking is judged normal by the error checking step, and reads a next item.

Moreover, in the storage medium readable by a computer, the storage medium storing the writing program of the image forming apparatus of the present invention, the control information necessary to print electronic image data is added with error check codes per printing, and is further encrypted by the cryptographic key and stored at the plural locations of the IC memory, one item at each location.

According to the present invention, when reading data held at plural locations, a data destruction detection part can decrypt data at even one location, and if CRC error checking is judged normal, the read data is determined to be valid and not destroyed. Thereby, communication time due to useless repeated reading or redundant processing time due to majority decision processing can be curbed.

The entire disclosure of Japanese Patent Application No. 2003-385780 filed on Nov. 14, 2003 including specification, claims, drawings and abstract is incorporated herein by reference in its entirety.

1. An image forming apparatus comprising:
a controller that controls an IC memory that stores control information necessary to print electronic image data and is mountable in and dismountable from a main body thereof, and devices within the main body for printing; and reading means for reading the control information from the IC memory,
wherein the image forming apparatus comprises:
decrypting means for decrypting the control information encrypted using a cryptographic key stored in advance;
error checking means for detecting an error by checking the control information obtained by the decrypting means with error check codes added in advance; and
destruction judgment means for judging whether the control information is destroyed, by information of the decrypting means and the error checking means, and
the destruction judgment means can decrypt the control information at even one location, the control information being stored at a plurality of locations of the IC memory, one item at each location, and terminates item reading if the checking is judged normal by the error checking means.

2. The image forming apparatus according to claim 1, further comprising:
block reading means for reading a plurality of pieces of the control information from the IC memory on a block basis,
wherein the destruction judgment means can decrypt, in the unit of a block containing a plurality of items, the control information at even one location, the control information being stored at the plurality of locations of the IC memory, each one of the items at each location, and terminate reading of one item if the checking is judged normal by the error checking means, and read a next item.

3. The image forming apparatus according to claim 1,
wherein the control information necessary to print electronic image data is added with error check codes per printing, and is further encrypted by the cryptographic key and stored at the plurality of locations of the IC memory, one item at each location.

4. A writing method of an image forming apparatus that comprises a control process that controls an IC memory that stores control information necessary to print electronic image data and is mountable in and dismountable from the main body, and devices within the main body for printing; and a reading process that reads the control information from the IC memory,
wherein the writing method comprises:
a decrypting process that decrypts the control information encrypted using a cryptographic key stored in advance;
an error checking process that detects an error by checking the control information obtained by the decrypting process with error check codes added in advance; and
a destruction judgment process that judges whether the control information is destroyed, by information of the decrypting process and the error checking process, and
the destruction judgment process can decrypt the control information at even one location, the control information being stored at a plurality of locations of the IC memory, one item at each location, and terminates item reading if the checking is judged normal by the error checking process.

5. The writing method of the image forming apparatus according to claim 4, further comprising a block reading process that reads a plurality of pieces of the control information from the IC memory on a block basis,
wherein the destruction judgment process can decrypt, in the unit of a block containing a plurality of items, the control information at even one location, the control information being stored at the plurality of locations of the IC memory, each one of the items at each location, and terminates reading of one item if the checking is judged normal by the error checking process, and reads a next item.

6. The writing method of the image forming apparatus according to claim 4,
wherein the control information necessary to print electronic image data is added with error check codes per printing, and is further encrypted by the cryptographic key and stored at the plurality of locations of the IC memory, one item at each location.

7. A storage medium readable by a computer, the storage medium storing a writing program of an image forming apparatus executable by the computer, comprising a control step that controls an IC memory that stores control information necessary to print electronic image data and is mountable in and dismountable from the main body, and devices within the main body for printing; and a reading step that reads the control information from the IC memory,
wherein the writing method comprises:
a decrypting step that decrypts the control information encrypted using a cryptographic key stored in advance;
an error checking step that detects an error by checking the control information obtained by the decrypting step with error check codes added in advance; and
a destruction judgment step that judges whether the control information is destroyed, by information of the decrypting step and the error checking step, and
the destruction judgment step can decrypt the control information at even one location, the control information being stored at a plurality of locations of the IC memory, one item at each location, and terminates item reading if the checking is judged normal by the error checking step.

8. The storage medium readable by a computer, the storage medium storing the writing program of the image forming apparatus according to claim 7, comprising a block reading step that reads a plurality of pieces of the control information from the IC memory on a block basis,
wherein the destruction judgment step can decrypt, in the unit of a block containing a plurality of items, the control information at even one location, the control information being stored at the plurality of locations of the IC memory, each one of the items at each location, and terminates reading of one item if the checking is judged normal by the error checking step, and reads a next item.

9. The storage medium readable by a computer, the storage medium storing the writing program according to claim 7,
wherein the control information necessary to print electronic image data is added with error check codes per printing, and is further encrypted by the cryptographic key and stored at the plurality of locations of the IC memory, one item at each location.
